(19) United States
(12) Patent Application Publication
(10) Pub. No.: US 2025/0287986 A1
(43) Pub. Date: Sep. 18, 2025

(54) MICRO-PUREE MACHINE WITH STORAGE CONTAINER

(71) Applicant: SharkNinja Operating LLC, Needham, MA (US)

(72) Inventors: Nick Lerwill, Brighton, MA (US); Jonathan James, Providence, RI (US); Lukas Tubby, Auburn, MA (US); Nathan Lyell, Brighton, MA (US)

(73) Assignee: SharkNinja Operating LLC, Needham, MA (US)

(21) Appl. No.: 18/606,968

(22) Filed: Mar. 15, 2024

(51) Int. Cl. A23P 30/20; A23G 9/22

(52) U.S. Cl. CPC A23P 30/20; A23G 9/224

(57) ABSTRACT

An example extrusion storage is provided. The extrusion storage includes an extrusion component used in extruding food material from a micro-puree machine. The extrusion storage includes an extrusion lid of the micro-puree machine. The extrusion lid is configured to protect at least one internal component of the micro-puree machine when a processing bowl of the micro-puree machine is removed. A container stores the extrusion component and the extrusion lid of the micro-puree machine. A first side of the container is configured to internally receive and protect the extrusion component. A second side of the container is configured to be coupled to the extrusion lid resulting in an assembled container. The assembled container is attached to the micro-puree machine.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets and the like, micro-puree machines can also prepare non-dessert types of foods such as non-dessert purees and mousses.

### SUMMARY

This disclosure includes systems, methods, and devices for storing one or more extrusion components and/or accessories efficiently in a storage container whereby the components are easily accessible to a user to facilitate extrusion of food ingredients from a processing bowl of a micro-puree machine. The micro-puree machine may include a first processing interface, i.e., a mixing interface, where food ingredients are shaved and/or mixed in a processing bowl and a second processing interface, i.e., an extrusion interface, where the mixed and/or processed food ingredients are extruded from the processing container. The processing container may be moveable from the mixing interface to the extruding interface and be re-configurable to enable extrusion of the processed food ingredients when the processing bowl and/or container is coupled to the extrusion interface of the micro-puree machine. At least one extrusion component may have to be added to the processing bowl to re-configure the processing bowl to perform extrusion of processed food ingredients. An extrusion component may include, without limitation, a plunger, plunger lid or cover, an extrusion nozzle assembly, a drip stop, or other extrusion enabling component(s). A storage assembly and/or storage container may be used to store at least one extrusion component while not in use, i.e., during machine transport or while food ingredients are being processed in the processing bowl when coupled to the mixing interface. The storage container may include a coupler that enables the storage container to couple to the extrusion interface while also being coupled to and/or storing at least one extrusion component in a housing and/or compartment of the storage container.

According to one aspect of the subject matter described in this disclosure, an exemplary storage container for a micro-puree machine is provided. The storage container includes an interface coupler configured to detachably connect the storage container to an extrusion interface of the micro-puree machine. A housing is configured to couple at least one extrusion component to the storage container.

In some implementations, the housing may include a component coupler configured to couple the at least one extrusion component to the storage container. The housing may include a compartment, the at least one extrusion component being coupled to the storage container via storage within the compartment. The housing may include a component coupler configured to couple a first extrusion component to the storage container and a compartment configured to store a second extrusion component. The at least one extrusion component may include one of a plunger, plunger lid, extrusion nozzle assembly (e.g., including an extrusion nozzle, extrusion dial and perhaps other components), and a drip stop.

According to another aspect of the subject matter described in this disclosure, an exemplary extrusion storage is provided. The extrusion storage includes a container for storing an extrusion lid and at least one component of a micro-puree machine. A first side of the container is configured to be coupled to the extrusion lid of the micro-puree machine, and a second side of the container is configured to store the at least one component of the micro-puree machine.

In some implementations, the container may be configured to receive internally the at least one extrusion component. The extrusion lid may include an opening for receiving a shaft positioned within the micro-puree machine. The extrusion lid may include a plunger used by the micro-puree machine for extruding the food material. The container may include a plurality of protruding sections for securely attaching the extrusion lid. The container may include a plurality of radial dials that bayonets on the micro-puree machine. The at least one extrusion component may be a removable drip stop for an extrusion nozzle of the micro-puree machine. The at least one extrusion component may be a nozzle of the micro-puree machine. The extrusion storage may include a cover for protecting the nozzle when stored in the first side of the container.

According to another aspect of the subject matter described in this disclosure, an exemplary extrusion storage is provided. The extrusion storage includes an extrusion component used in extruding food material from a micro-puree machine. An extrusion lid of the micro-puree machine, the extrusion lid configured to protect at least one internal component of the micro-puree machine when a processing bowl of the micro-puree machine is removed. A container for storing the extrusion component and the extrusion lid of the micro-puree machine. A first side of the container is configured to internally receive and protect the extrusion component and a second side of the container configured to be coupled to the extrusion lid resulting in an assembled container. The assembled container is attached to the micro-puree machine.

In some implementations, the extrusion lid may include an opening for receiving a shaft positioned within the micro-puree machine. The extrusion lid may include a plunger used by the micro-puree machine for extruding the food material. The container may include a plurality of protruding sections for securely attaching the extrusion lid. The assembled container may include a plurality of radial dials that bayonets on the micro-puree machine. The extrusion component may be a removable drip stop for an extrusion nozzle of the micro-puree machine. The extrusion component may be a nozzle of the micro-puree machine. The extrusion may include a cover for protecting the nozzle when stored on the first side of the container.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIGS. 1A-1M are schematic diagrams of an example micro-puree machine 100.

FIGS. 2A-2C are schematic diagrams of an example extrusion nozzle assembly used with a micro-puree machine.

FIGS. 3A-3B are schematic diagrams of different views of the extrusion nozzle assembly of FIG. 2.

FIGS. 4A-4B are schematic diagrams of cross-sectional views of the extrusion nozzle assembly of FIG. 2.

FIG. 5 is a schematic diagram of a micro-puree machine with an example drip tray and an example extrusion storage.

FIGS. 6A-6B are detailed schematic diagrams of the drip tray of FIG. 5.

FIGS. 7A-7C are detailed schematic diagrams of the extrusion storage of FIG. 5.

FIGS. 8A-8B are schematic diagrams of another example extrusion storage.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example implementations only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In the specification and claims, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This disclosure describes a micro-puree machine having extrusion storage. The extrusion storage provides the user of the micro-puree machine an option for storing the extrusion lid including at least one other extrusion component, such as a drip stop or detachable nozzle, when the micro-puree machine is not in use. Moreover, the micro-puree machine is provided with a drip stop for protecting and collecting spillage from an extrusion nozzle when closed.

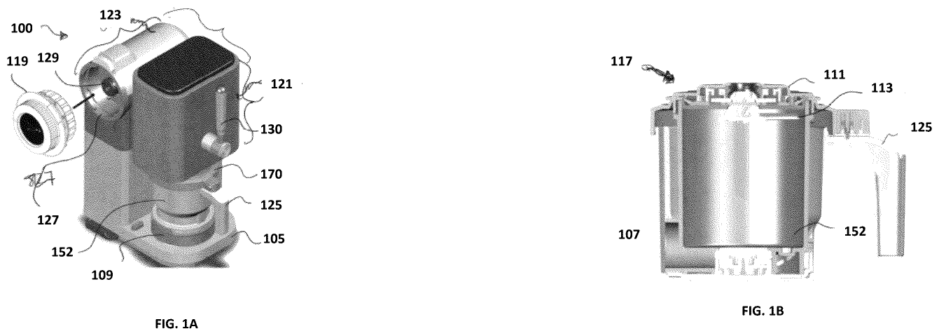

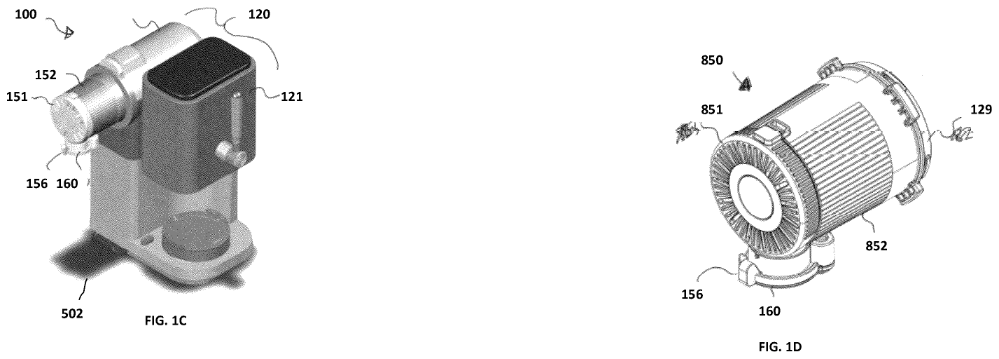

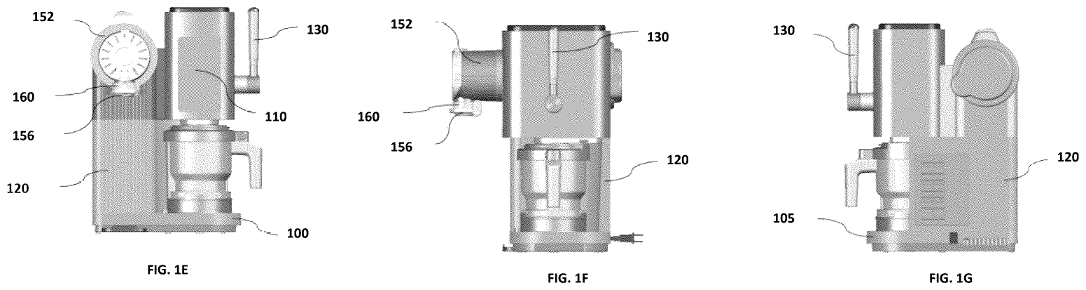

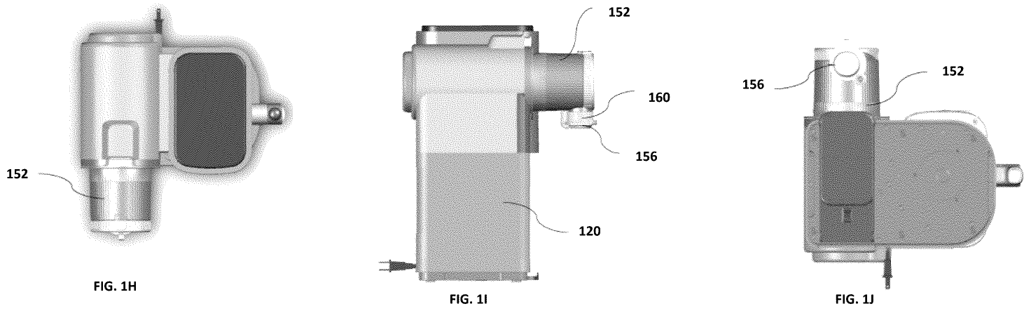

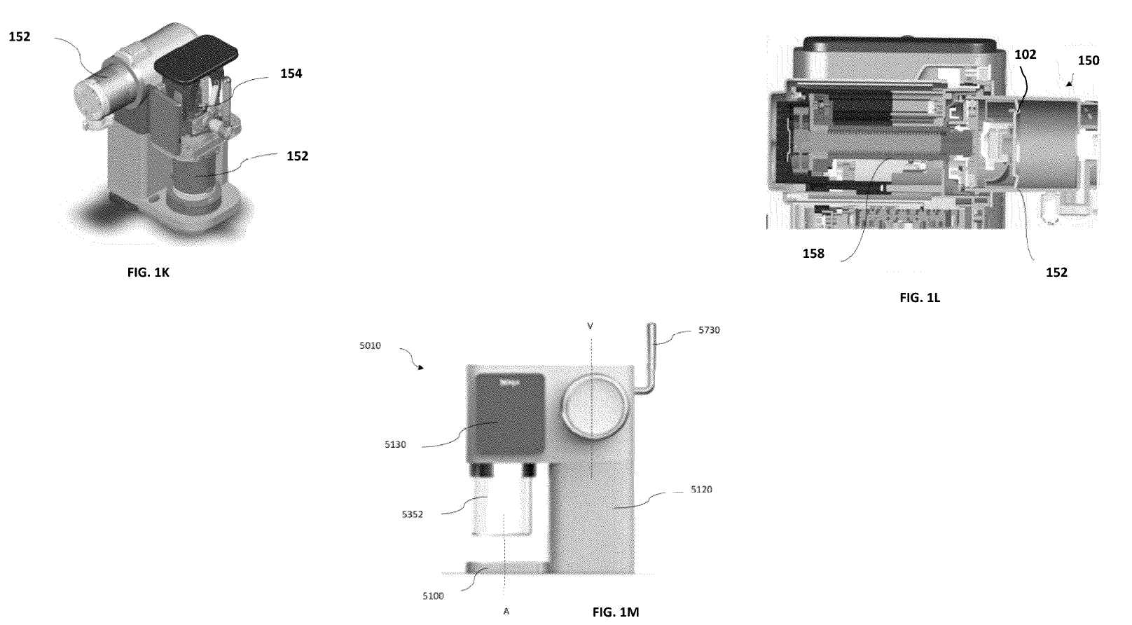

FIGS. 1A-1M are schematic diagrams of an example micro-puree machine 100. FIGS. 1A and 1B illustrate an embodiment of micro-puree machine 100 in a first configuration for processing (e.g., micro-pureeing), which may be referred to herein as a processing configuration. FIGS. 1C and 1D illustrate an embodiment of micro-puree machine 100 in a first configuration for extruding, which may be referred to herein as an extruding or extrusion configuration. FIGS. 1E-1L illustrate an embodiment of micro-puree machine 100 in both processing and extruding configurations merely for illustrative purposes, as in some embodiments, the micro-puree is not configured to perform processing and extruding concurrently.

The micro-puree machine 100 may include a base 105 and a housing 120. The housing 120 may include a user interface 110 for receiving user inputs to control the micro-puree machine 100 and/or display information. In some embodiments, the micro-puree machine includes a processing sub-module 121 including one or more components configured to process ingredients in a processing bowl 152 and an extruding sub-module 123 including one or more components configured to extrude processed ingredients from the processing bowl 152. Micro-puree machine 100 also includes an extrusion interface 129 whereby the processing bowl 152 can be coupled to the micro-puree machine 100 to facilitate extrusion of processed ingredients. Mixing interface 170 and extrusion interface 129 may include, without limitation, bayonet couplers, threaded couplers, snap-on couplers, and the like, that enable processing bowl 152 to detachably connect and/or couple the respective interface for mixing or extruding processed ingredients. In implementations where the mixing interface 170 and extrusion interface 129 include bayonet couplers, the couplers may include one or more female receptors and/or receivers on the micro-puree machine housing that engage with one or more male bayonet protrusions or bayonet tabs of a coupler of the processing bowl 152 when the processing bowl 152 is coupled to the mixing interface 170 or extrusion interface 172.

In a processing configuration, the processing bowl 152 may be coupled to the interior of an outer bowl 107 that is mounted on a processing platform 109 mounted to the base 105. The processing bowl 152 may be coupled to a lid 111 that houses a blade assembly 113. The processing bowl 152 may include a nozzle control assembly 151 (e.g., a dial) that enables a user to control an opening or closing of a nozzle 160 and a drip stop 156 that can be used by a user to selectively cover the nozzle 160, or the control assembly 151. In some implementations, the nozzle control assembly 151, the nozzle 160, and the drip stop 156 may be removably attachable to the processing bowl 152. Using the handle 125, a user may rotate and elevate the processing bowl assembly 117 into a processing position in which the blade assembly 113 engages with a driven shaft 154, the lid 111 couples to the micro-puree machine, and a blade is released from the lid 111 so the driven shaft 154 can drive the shaft 154, for example, as described in the as described in U.S. Pat. No. 11,871,765 to SharkNinja Operating, LLC, the entire contents of which are hereby incorporated by reference (the '756 patent). By engaging the user interface (or via a remote interface wirelessly connected to a wireless interface within housing 120), the user may initiate processing of the ingredients in the processing bowl 152. In a processing configuration, extruding sub-module 123 may remain idle, and a cap or plug 119 may be coupled to a coupling 127, covering an interface 129 with driven shaft 158.

After the processing of the ingredients, the processing bowl assembly 117 may be decoupled from the micro-puree machine 110 (e.g., from the processing sub-module 121), and de-mounted from the platform 109. The lid 111 may be removed from the outer bowl 107, and processing bowl 152 removed from the outer bowl 107. A lid 153 then may be mounted to the processing bowl 152, and the processing bowl 152 then may be coupled to the micro-processing machine 110 (e.g., to the extruding sub-module 123) in an extruding configuration.

In the extruding configuration, the processing bowl 152 may be coupled to a lid 153 that includes a plunger. The combination of the processing bowl 152 and the lid 153 may be referred to herein as a bowl extruding assembly 150. In embodiments, the bowl extruding assembly 150 may be configured to be installed to the micro-puree machine 100 such that the nozzle 160 faces vertically downwards when the bowl extruding assembly 150 is properly installed. The bowl extruding assembly 150 may be assembled to the housing 120 (e.g., the extruding sub-module 123) such that a central axis A of the bowl extruding assembly 150 extends perpendicular to a vertical axis V of the housing 120, as shown. The bowl extruding assembly 150 may include an outlet 160 for extruding processed ingredients from the bowl extruding assembly 150. The micro-puree machine 100 also may include a lever 130 for manually activating a plunger 102 to extrude processed ingredients within the bowl extruding assembly 150 through the outlet 160.

While the lever 130 is illustrated on a right side of the machine 100 (from the front view shown in FIG. 1B), the disclosure is not so limited. The lever 130 may be on the left side of, or another location on, the machine 100, and other components of the machine may be rearranged to accommodate the different location of the lever 130. The housing 120 may include electrical, electromagnetic, mechanical and/or electro-mechanical components to translate a pulling down or pushing up of the lever 130 into movement of a plunger (e.g. plunger 102) within the processing bowl 152.

Implementations of the housing 120 of micro-puree machine 100 may house a transmission system that includes a driven shaft 154 for engaging the blade 300, a separate driven shaft 158 for engaging the plunger 102, on or more gearing systems, and one or more position and/or drive motors for moving the driven shaft 154 and the other shaft 158 rotationally and/or axially to process the ingredients in the bowl assembly 150. For example, a drive motor may drive the rotation of the driven shaft 154 and blade coupled thereto, and a position motor may drive the vertical (e.g., down and up) movement of the driven shaft and a blade. Another motor may drive the second shaft 158 and a plunger attached thereto. In embodiments, the blade 113 may be programmably controlled at the user interface 110 by a computing system to operate at different rotational speeds and moved up and down in different patterns and speeds, and for different periods of time, to make different food items. In embodiments, the plunger in the lid 153 may be programmably controlled at the user interface 110 by a computing system to operate at different rotational speeds and moved up and down in different patterns and speeds, and for different periods of time, to make different food items. Some non-limiting examples of a transmission system and the computing system are shown in described in the '765 patent and in U.S. Pat. No. 11,882,965 to SharkNinja Operating, LLC (the '965 patent), the entire contents of which are hereby incorporated by reference.

FIG. 1M shows an isometric view of a micro-puree machine 5010, according to another embodiment of the disclosure. The micro-puree machine 5010 may be used to process ingredients on one shaft and extrude the processed ingredients on another shaft. As shown in FIG. 1M, the micro-puree machine 5010 may include a base 5100, a housing 5120, and an extrusion module 5130. The housing 5120 may include a user interface (not shown) for receiving user inputs to control the micro-puree machine 5010 and/or display information. The micro-puree machine 5010 also may include a bowl 5352. The bowl 5352 may be assembled to the housing 5120 such that a central axis A of the bowl 5352 extends parallel to a vertical axis V of the housing 5120, as shown. However, the disclosure contemplates that the bowl 5352 may be assembled to the housing 5120 such that the central axis A extends at an angle of between 0 and 90° to the vertical axis V, or such that the central axis A extends perpendicular to the vertical axis V.

The extrusion module 5130 may be configured to couple to a bowl assembly as described herein, for example, a bowl having a lid with e a plunger housed therein. The extrusion module 5130 also may include a motor and transmission to drive a driven shaft to move the plunger with the bowl during extrusion, for example, as described elsewhere herein. The micro-puree machine 5010 also may include a lever 5730 for activating the plunger to extrude processed ingredients from the bowl 5352 through an integrated nozzle in the bowl 5352 (not shown). The housing 5120 may include electrical, electromagnetic and/or mechanical components the translate a pulling down or pushing up of the lever into movement of the plunger within the bowl.

The nozzle may be integrated with the bottom surface of the bowl 5352 such that nozzle faces vertically downwards when the bowl 5352 is properly installed. In the embodiment of FIG. 1J, the plunger may be configured to extrude the processed ingredients from the bowl 5352 using a separate shaft (not shown) from a driven shaft (e.g., 250) that rotates a blade (e.g., 300). In further embodiments, the separate shaft may be manually driven by the user by cranking the lever 5730.

In some embodiments of the disclosure, a drip stop for an extrusion nozzle of a micro-processing machine (or other type of device for processing food) may be provided, as now will be described.

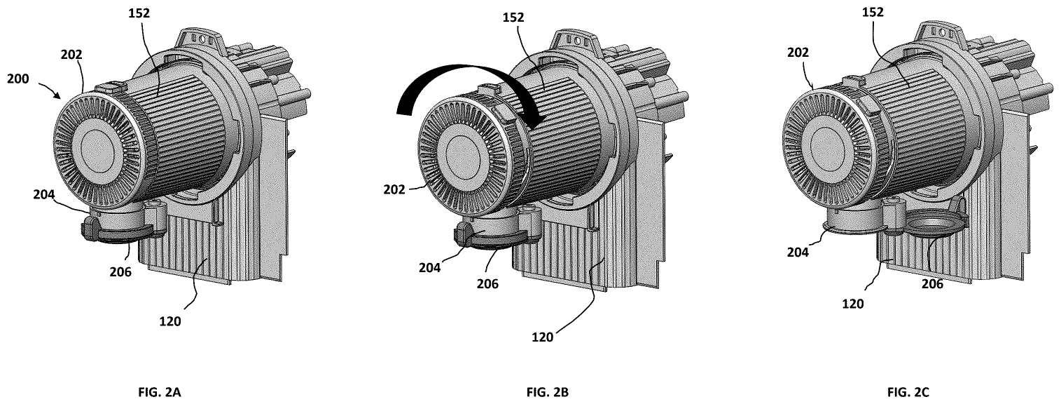

FIGS. 2A-2C are schematic diagrams of an example extrusion nozzle assembly 200 used with a micro-puree machine. In this implementation, the micro-puree machine is similar to micro-puree machine 100 of FIG. 1. Extrusion nozzle assembly 200 may include a radial dial 202, a nozzle 204, a drip stop 206, and protruding sections 208 and 210. When protruding rib sections 208 and 210 are aligned, as shown in FIG. 2A, this indicates that extrusion nozzle assembly 200 is in a closed position. Otherwise, extrusion nozzle assembly 200 is in an open position, as shown in FIGS. 2B and 2C. To extrude processed ingredients (e.g., frozen or semi-frozen food material) in processing bowl 152, a user may rotate radial dial 202 to the open position to start a flow path from inside processing bowl 152 through nozzle 204, as shown in FIG. 2B. However, the user can still not extrude until drip stop 206 detaches from nozzle 204 and is rotated into the open position, as shown in FIG. 2C.

Extrusion nozzle assembly 200 may include a bayonet coupling and may be detached for cleaning. Moreover, extrusion nozzle assembly 200 may be tethered to processing bowl 152 by a strap or the like. In some implementations, extrusion nozzle assembly 200 may work with other micro-puree machines besides micro-puree machine 100.

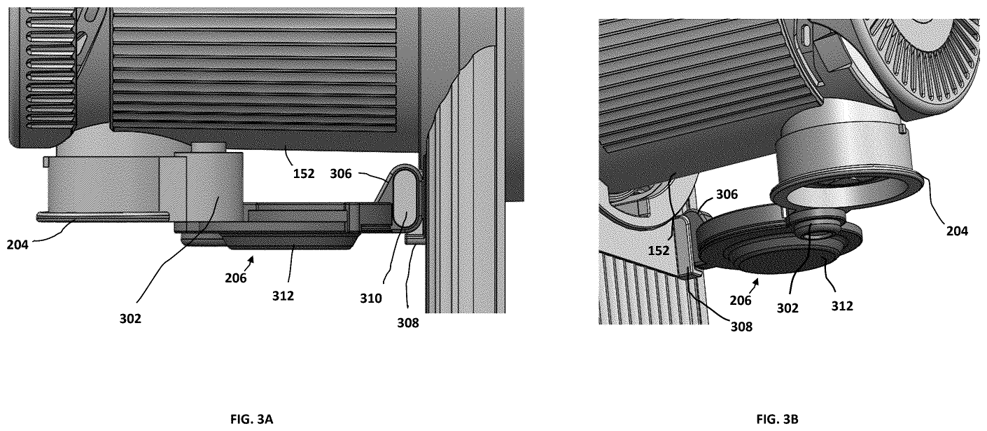

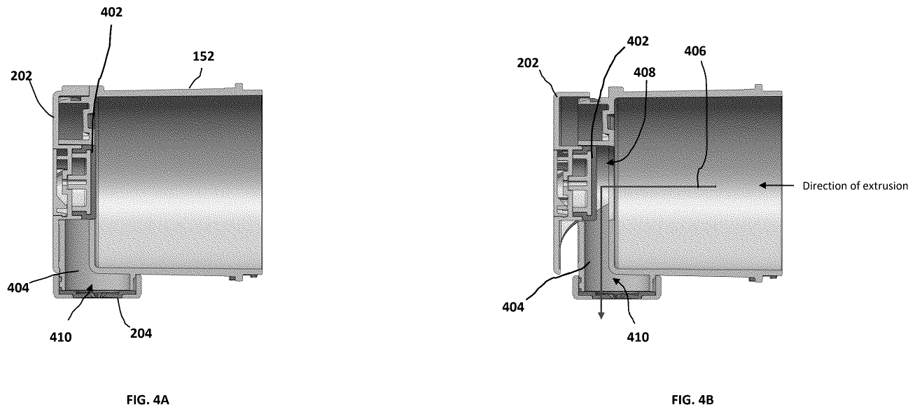

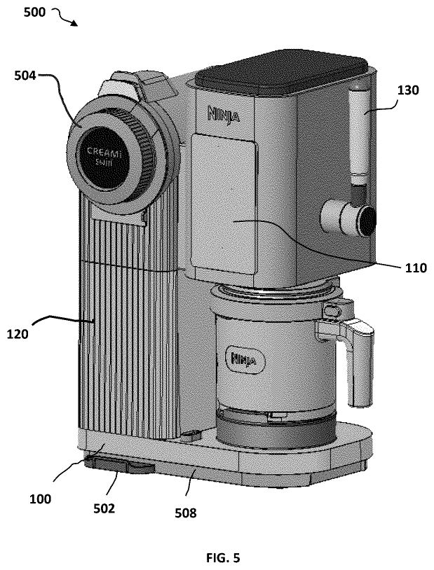

FIGS. 3A-3B are schematic diagrams of different views of extrusion nozzle assembly 200 of FIG. 2. FIG. 3A is a side view of extrusion nozzle assembly 200 showing nozzle 204 coupled to drip stop 206 via a hinge 302. Drip stop 206 may include a plate 312 and finger grip 306 positioned on plate 312. Plate 312 may be configured to protect and collect spillage from nozzle 204 when idled or in the closed position. Hinge 302 may extend vertically from processing bowl 152, where nozzle 204 connects to one side of hinge 302, and one end of drip stop 206 connects to the bottom of hinge 302.

Drip stop 206 may be configured to rotate about hinge 302. The other end of drip stop 206 may connect to housing 120 via a finger grip 306 on a finger grip holder 308, as shown in FIG. 3B. A user may move finger grip 306 in a rotated motion to finger grip holder 308. Holder 308 may connect to housing 120 of the micro-puree machine 100. Finger grip 306 may include a magnet 310, and when drip stop 206 is in the open position, magnet 308 may align with a hall sensor or reed switch in housing 120 to indicate to micro-puree machine 100 that it is in the open position. This prevents the user from extruding until drip stop 206 is in the open position.

In other implementations, magnet 310 may be placed in a different location on finger grip 306 to align with a hall sensor or reed switch in housing 120.

FIGS. 4A-4B are schematic diagrams of cross-sectional views of an example extrusion nozzle assembly 200 of FIG. 2. FIG. 4A shows protruding rib sections 208 and 210 being aligned, indicating extrusion 200 is in the closed position. Extrusion nozzle assembly 200 may include a plunger 402, plunger channel 404, an inlet 408, and an outlet 410. Inlet 408 may be arranged to receive the processed ingredient from the processing bowl 152 and outlet 410 is arranged to output the processed ingredients from extrusion nozzle assembly 200. When extrusion nozzle assembly 200 is closed, plunger 402 may seal inlet 408 from an opening at one end of processing bowl 152 from which frozen food materials are extruded. As described herein, when the user moves dial 202 to the open position, resulting in protruding rib sections 208 and 210 being misaligned, plunger 402 unseals the opening, allowing frozen food materials to extrude into inlet 408, as shown by arrow 406, through plunger channel 404 of outlet 410 and out to nozzle 204 when drip stop 206 is in the open position.

In this implementation, plunger 402 may unseal the opening through lever actuation due to the movement of dial 202. In other implementations, plunger 402 may unseal the opening using MEMS actuation or the like.

In some embodiments of the disclosure, a drip tray, for example, a movable drip tray, for an extrusion component of a micro-puree machine, may be provided, as now will be described.

FIG. 5 is a schematic diagram of a micro-puree machine 500 with an example drip tray 502 and an example extrusion storage assembly 504. Micro-puree machine 500 may be similar to micro-puree machine 100 of FIG. 1, except that processing bowl 152, including extrusion nozzle assembly 200, may be removed. Moreover, micro-puree machine 500 may include a drip tray 502 and an extrusion storage assembly 504. Drip tray 502 may be positioned in an opening of base 508 of micro-puree machine 500. Moreover, drip tray 502 may extend horizontally underneath nozzle 204 to collect any spillage from extrusion nozzle 204 when processing bowl 152 is used. Extrusion storage assembly 504 may protect the interior components of micro-puree machine 500 in housing 120, such as interior couplings and a driven shaft, when processing bowl 152 is removed. In this implementation, a driven shaft may extend through the coupling to couple with either a blade or a plunger housed within an extrusion lid. Further details regarding drip tray 502 and extrusion storage assembly 504 are provided below.

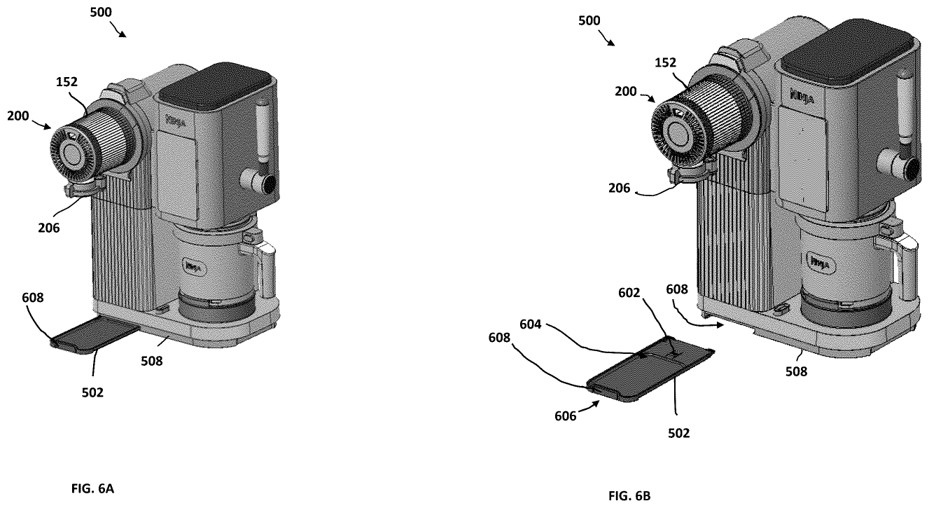

FIGS. 6A-6B are detailed schematic diagrams of drip tray 502 of micro-puree machine 500 connected with processing bowl 152 and extrusion nozzle assembly 200. As shown in FIG. 6A, drip tray 502 may include a grip 608 used for horizontally extending drip tray 502 to be positioned underneath nozzle 204 of micro-puree machine 500 to collect any spillage from extrusion nozzle assembly 200 when processing bowl 152 is in use. Drip tray 502 may include a latch 602 and a rib section 604 to securely position it in opening 608 of base 508, as shown in FIG. 6B. Latch 602 may be positioned on rib section 604. Rib section 604 may provide structural support to latch 602. Drip tray 502 may be sized to horizontally extend from base 508 to an open position underneath extrusion nozzle assembly 200 without being removed from base 508.

When this occurs, rib section 604 may be located at the exact location as front portion 606 of drip tray 502 is located when drip tray 502 is in a close position, as shown in FIG. 5. A user may also remove drip tray 502 from base 508 for cleaning by further extending drip tray 502 beyond rib section 604 resulting in latch 604 detaching from base 508 and complete removal of drip tray 502 from micro-puree machine 500, as shown in FIG. 6B. The user may reattach drip tray 502 to base 508 by sliding drip tray 502 into opening 608 until rib section 604 is correctly aligned with opening 608 so latch 604 is attached to base 508. Once latch 604 may attach to base 508, the user may further slide the remaining portion of drip 604 into opening 608. Drip tray 502 may be made from non-corrosive plastics or metals.

In some embodiments of the disclosure, a storage container for extrusion components (and/or other components) of a micro-processing machine (or other type of device for processing food) may be provided, as now will be described.

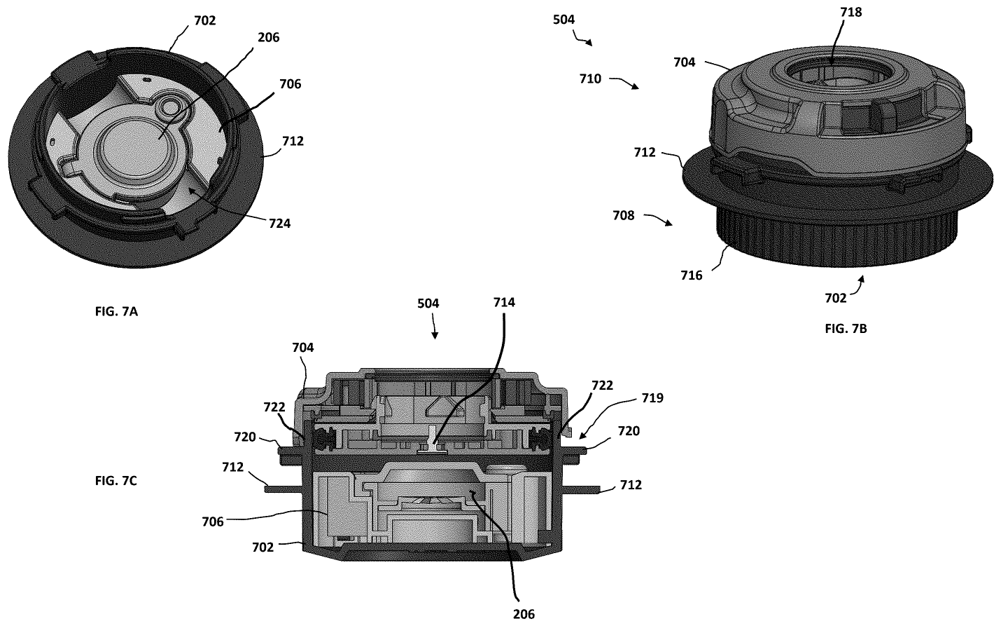

FIGS. 7A-7C are schematic diagrams of an extrusion storage assembly 504 of FIG. 5. Extrusion storage assembly 504 may provide storage for drip stop 206 and the extrusion lid of micro-puree machine 500 when the processing bowl 352 has been removed. Moreover, extrusion storage assembly 504 may prevent spillage of food materials, including protecting the interior components of micro-puree machine 500 in housing 120 when processing bowl 152 is removed. Extrusion storage assembly 504 may include a storage container 702 and an extrusion lid 704.

Storage container 702 may provide storage for drip stop 206 when processing bowl 152 is removed, as shown in FIG. 7A. Storage container 702 may include housing 724 defining a compartment 706 specifically designed to receive and protect drip stop 206. Extrusion lid 704 may be associated with the same extrusion lid that houses extrusion plunger 714 used by micro-puree machine 500. Both storage container 702 and extrusion lid 704 may be arranged where extrusion lid 704 is attached to storage container 702, forming extrusion storage assembly 504, as shown in FIG. 7B.

Extrusion storage assembly 504 may include a circular flap 712 that separates the front portion 708 and back portion 710 of extrusion storage assembly 504. Front portion 708 of extrusion storage assembly 504 may be external to micro-puree machine 500 while back portion 710 is positioned internally to the micro-puree machine 500. Also, front portion 708 of extrusion storage assembly 504 may include a dial 716 that may be rotated by a user to couple the extrusion storage assembly 504 to micro-puree machine 500 via bayonet tabs of coupler 719. The user may press storage assembly 504 against back portion 710, which includes extrusion lid 704 with an opening 718 to receive and protect the driven shaft of micro-puree machine 500.

FIG. 7C shows a cross-sectional view of extrusion storage and/or storage assembly 504. As depicted, drip stop 206 is positioned in container 702 while extrusion plunger 714 is positioned in extrusion lid 704. Storage container 702 may include an interface coupler 719 having several protruding sections or bayonet tabs 720, including upper portions 722 extending vertically from protruding sections 720. Moreover, each outer portion 722 of the storage container 702 may form a component coupler that is positioned within extrusion lid 704, allowing the extrusion lid 704 to be securely locked with and/or coupled to storage container 702 to form extrusion storage assembly 504.

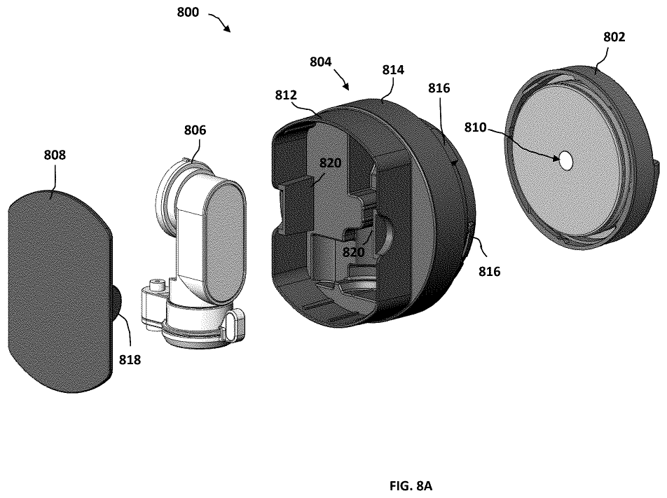

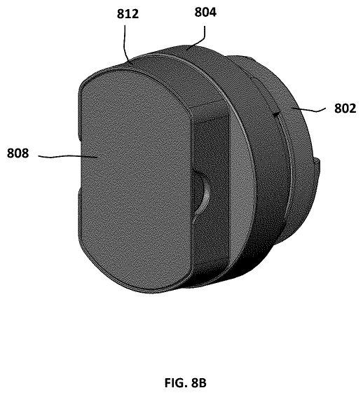

FIGS. 8A-8B are schematic diagrams of another example extrusion storage and/or storage assembly 800. Extrusion storage 800 may work with micro-puree machine 100 or the like. Extrusion storage 800 may prevent spillage of food materials, including protecting the interior components of micro-puree machine 500 in housing 120, such as interior couplings and a driven shaft, when processing bowl 152 is removed. Moreover, extrusion storage 800 may store components used to extrude frozen materials when processing bowl 152 is not in use. FIG. 8A shows the exploded view of extrusion storage 800 having an extrusion lid 802 of micro-puree machine 100, a storage container 804, an inlet 806 of micro-puree machine 500, and a cover 808, as shown in FIG. 8A. Extrusion lid 802 may include an opening 810 for receiving and protecting the driven shaft of micro-puree machine 100. Moreover, inlet 806 may be a detachable nozzle used by micro-puree machine 500. In some implementations, inlet 806 may be replaced by other extrusion components used by micro-puree machine 500 for storage.

Moreover, extrusion lid 802 may house the extrusion plunger used by micro-puree machine 100 for extrusion. Storage container 804 may include an inlet protection portion 812 for housing inlet 806 and a coupling section 814 that is securely connected to the extrusion lid. Cover 808 may be securely placed on the open side of inlet protection portion 812 to protect inlet 806.

FIG. 8B shows the assembled view of extrusion storage 800. In this implementation, coupling section 814 and extrusion lid 802 may be attached and positioned within micro-puree machine 500. Coupling section 814 may include several protruding sections 816 that securely lock extrusion lid 802 in place, allowing for coupling section 814 and extrusion lid 802 to be attached. Also, inlet protection 812 and cover 808 may be attached and positioned at the exterior of micro-puree machine 500. Cover 808 may include one or more protruding sections 818, and inlet protection 812 contains one or more receiving portions 820 for receiving the one or more protruding sections 818 to securely connect cover 808 to inlet protection 812. In this implementation, one or more protruding sections 818 may snap into one or more receiving portions 820. In other implementations, one may connect one or more protruding sections 818 to one or more receiving portions 820 using other means besides that described here.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A storage container for a micro-puree machine comprising:
an interface coupler configured to detachably connect the storage container to an extrusion interface of the micro-puree machine; and
a housing configured to couple at least one extrusion component to the storage container.

2. The storage container of claim 1, wherein the housing includes a component coupler configured to couple the at least one extrusion component to the storage container.

3. The storage container of claim 1, wherein the housing includes a compartment, the at least one extrusion component being coupled to the storage container via storage within the compartment.

4. The storage container of claim 1, wherein the housing includes a component coupler configured to couple a first extrusion component to the storage container and a compartment configured to store a second extrusion component.

5. The storage container of claim 1, wherein the at least one extrusion component includes one of a plunger, plunger lid, extrusion nozzle, extrusion dial, and a drip stop.

6. An extrusion storage comprising:
a container for storing an extrusion lid and at least one component of a micro-puree machine, a first side of the container configured to be coupled to the extrusion lid of the micro-puree machine and a second side of the container is configured to store the at least one component of the micro-puree machine.

7. The extrusion storage of claim 6, wherein the container is configured to receive internally the at least one extrusion component.

8. The extrusion storage of claim 6, wherein the extrusion lid comprises an opening for receiving a shaft positioned within the micro-puree machine.

9. The extrusion storage of claim 6, wherein the extrusion lid comprises a plunger used by the micro-puree machine for extruding the food material.

10. The extrusion storage of claim 6, wherein the container comprises a plurality of protruding sections for securely attaching the extrusion lid.

11. The extrusion storage of claim 6, wherein the container comprises a plurality of radial dials that bayonets on the micro-puree machine.

12. The extrusion storage of claim 6, wherein the at least one extrusion component is a removable drip stop for an extrusion nozzle of the micro-puree machine or a nozzle of the micro-puree machine.

13. The extrusion storage of claim 12, further comprising a cover for protecting the nozzle when stored in the first side of the container.

14. An extrusion storage comprising:
an extrusion component used in extruding food material from a micro-puree machine;
an extrusion lid of the micro-puree machine, the extrusion lid configured to protect at least one internal component of the micro-puree machine when a processing bowl of the micro-puree machine is removed; and
a container for storing the extrusion component and the extrusion lid of the micro-puree machine, a first side of the container configured to internally receive and protect the extrusion component and a second side of the container configured to be coupled to the extrusion lid resulting in an assembled container, wherein the assembled container is attached to the micro-puree machine.

15. The extrusion storage of claim 14, wherein the extrusion lid comprises an opening for receiving a shaft positioned within the micro-puree machine.

16. The extrusion storage of claim 14, wherein the extrusion lid comprises a plunger used by the micro-puree machine for extruding the food material.

17. The extrusion storage of claim 14, wherein the container comprises a plurality of protruding sections for securely attaching the extrusion lid.

18. The extrusion storage of claim 14, wherein the assembled container comprises a plurality of radial dials that bayonets on the micro-puree machine.

19. The extrusion storage of claim 14, wherein the extrusion component is a removable drip stop for an extrusion nozzle of the micro-puree machine or a nozzle of the micro-puree machine.

20. The extrusion storage of claim 19, further comprising a cover for protecting the nozzle when stored on the first side of the container.
